(19) United States
(12) Patent Application Publication
(10) Pub. No.: US 2005/0198506 A1
(43) Pub. Date: Sep. 8, 2005

(54) Dynamic key generation and exchange for mobile devices

(76) Inventors: Emily H. Qi, Portland, OR (US); Farid Adrangi, Lake Oswego, OR (US)

Correspondence Address: FISH & RICHARDSON, PC, 12390 EL CAMINO REAL, SAN DIEGO, CA, 92130-2081, US

(21) Appl. No.: 10/749,794

(22) Filed: Dec. 30, 2003

(51) Int. Cl. H04L 9/00

(52) U.S. Cl. 713/170; 713/168

(57) ABSTRACT

A method for dynamic generation and exchange of a key which may be used to authenticate messages between a mobile network device (e.g., a laptop computer) and a network device (e.g., a router) configured to route datagrams destined for the mobile network device.

### BACKGROUND

Mobile devices, such as a laptop computer, are commonly assigned a permanent Internet Protocol (IP) address by a home network. This IP address is used to route datagrams to the mobile device while it is on its home network. The mobile node, however, may leave its home network and later establish contact with its home network by way of a different IP address. In this case, datagrams destined for the permanent address of the mobile node need to be rerouted to the address at which the mobile node has established contact with the home network. Internet Engineering Task Force (IETF) Request for Comments 3344, IP Mobility Support for IPv4, August 2002 describes a protocol for allowing transparent routing of Internet Protocol (IP) datagrams to mobile nodes over the Internet. According to this protocol, the mobile node transmits a Registration Request message to a home agent (e.g., a router) on the mobile node's home network notifying the home agent of a care-of address to which datagrams should be delivered. In response to receiving a Registration Request message, the home agent reroutes datagrams destined for the permanent IP address of the mobile node to a “care-of address” indicated in the Registration Request message. The IP Mobility Support for IPv4 protocol requires that the home agent authenticate the mobile node before rerouting datagrams to a care-of address.

### DESCRIPTION OF DRAWINGS

FIG. 1A is a block diagram of a home network with two mobile nodes.

FIG. 1B is a block diagram of a home network where one of its mobile nodes is off the home network.

FIG. 2 is a flow chart of a process for dynamically generating a mobile IP key.

FIG. 3 is a diagram illustrating a procedure for obtaining a Kerberos session key and ticket for a home agent.

FIG. 4 is a flow chart of a process for dynamically generating and transmitting a mobile IP key.

### DETAILED DESCRIPTION

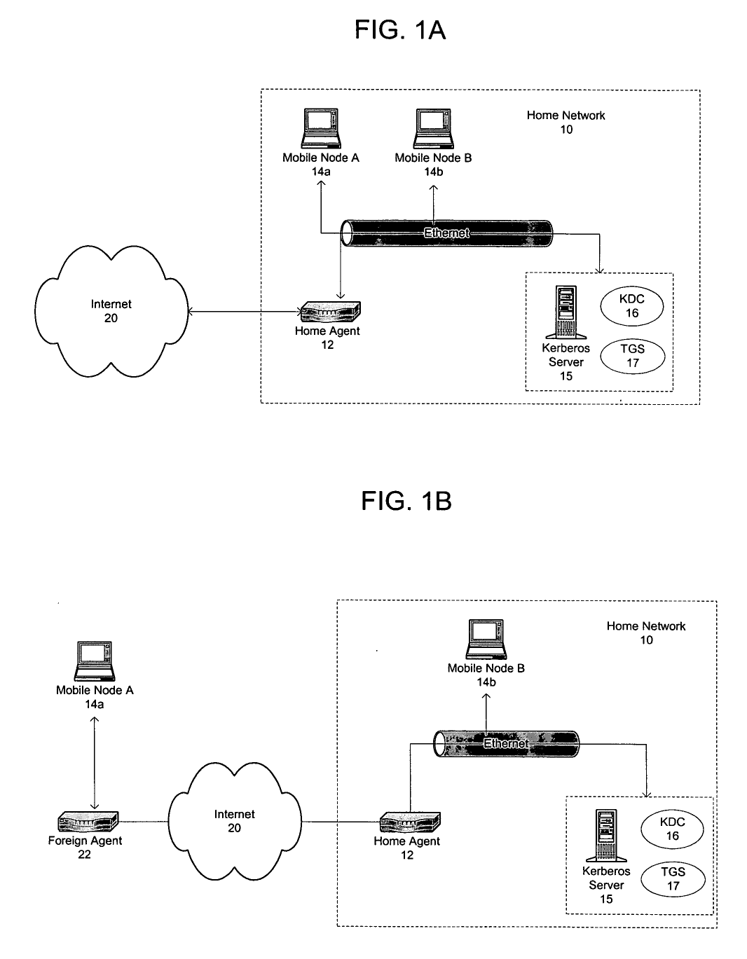

Referring to FIG. 1A, a home network 10 includes a home agent 12, two mobile nodes 14a-14b, and a key exchange server, for example a Kerberos server 15, in communication using an Ethernet network 18. The home network 10 is in communication with the Internet 20. The Kerberos server 15 includes a Kerberos Key Distribution Center 16 (KDC) and a Ticket Granting Service (TGS) application 17. As used below, in one example, a “Registration Request message” and a “Registration Reply message” are Registration Request and Registration Reply, messages respectively, defined in Internet Engineering Task Force (IETF) Request for Comments 3344, “IP Mobility Support for IPv4”, August 2002. Additionally, “Kerberos Authentication Service Request”, “Kerberos Authentication Service Reply”, “Kerberos Ticket Granting Service Request”, “Kerberos Ticket Granting Service Reply,” “Kerberos Application Request”, and “Kerberos Application Reply” refer to the corresponding messages defined in any version of the Kerberos Network Authentication Protocol, such as Kerberos Version 5 described in Network Working Group, Request for Comments 1510, The Kerberos Network Authentication Service (V5), September 1993.

In this example, each mobile node 14a-14b and home agent 12 are Kerberos security principals, and thus each has a private key known only to the device (i.e., the mobile node or home agent) and the Kerberos Key Distribution Center (KDC) located within the Kerberos server 15.

Each mobile node 14a-14b, shown as a laptop computer in FIG. 1A, can be any computer or other device (e.g., a router) that changes its point of attachment to the home network. The mobile node has a permanent (or home) IP address at which datagrams are delivered while the mobile node is connected into the home network. The home agent 12 is a router or other device on the mobile node's home network that tunnels datagrams to the point of attachment of the mobile node when it is away from the home network. The home agent 12 also maintains current location information of the mobile node when it is away from the home network.

Referring to FIG. 1B, one of the two mobile nodes, e.g., mobile node 14a, is from the home network 10 but in communication with the home network 10 through a foreign agent 22 using the Internet 20. The foreign agent 22 is a router or other device on a network being visited by the mobile node that provides routing services to the mobile node 14a. The foreign agent routes datagrams to the mobile node that were tunneled by the home agent. The foreign agent also serves as a router for datagrams sent by the mobile node.

The mobile node 14 accesses the home network via the foreign agent 22 using the protocol described in the Network Working Group Request for Comments (RFC) 3344, IP Mobility Support for IPv4, August 2002. This protocol provides a mechanism that enables a mobile node to change its point of attachment to the Internet without having to change the current transport connections of the mobile node 14a. According to this protocol, mobility agents (i.e., foreign agents and home agents) advertise their presence via Agent Advertisement Messages. A mobile node, e.g., mobile node 14a shown in FIG. 1B, receives these Agent Advertisements and determines whether it is on its home network or foreign network. If the mobile node detects that it is on a foreign network, it obtains a “care-of-address” on the foreign network, which may be determined from the foreign agent's advertisement message. The care-of address is the current point of entry of the mobile node to the Internet.

After receiving a care-of address, the mobile node 14a registers its care-of address with its home agent through exchange of Registration Request and Registration Reply messages. The Registration Request and Registration Reply messages are transmitted directly between the home agent and mobile node or via a foreign agent, e.g., foreign agent 22 shown in FIG. 1B. Once the mobile node has registered its care-of address with its home agent, datagrams sent to the mobile node's home address (i.e., its permanent IP address) are intercepted by its home agent, tunneled by the home agent to the mobile node's care-of address, received at the tunnel endpoint (which is either at a foreign agent or at the mobile node itself), and finally delivered to the mobile node. In the reverse direction, datagrams sent by the mobile node are delivered to their destination using standard IP routing mechanisms. Alternatively, datagrams sent by the mobile node may be reversed tunneled to the home agent.

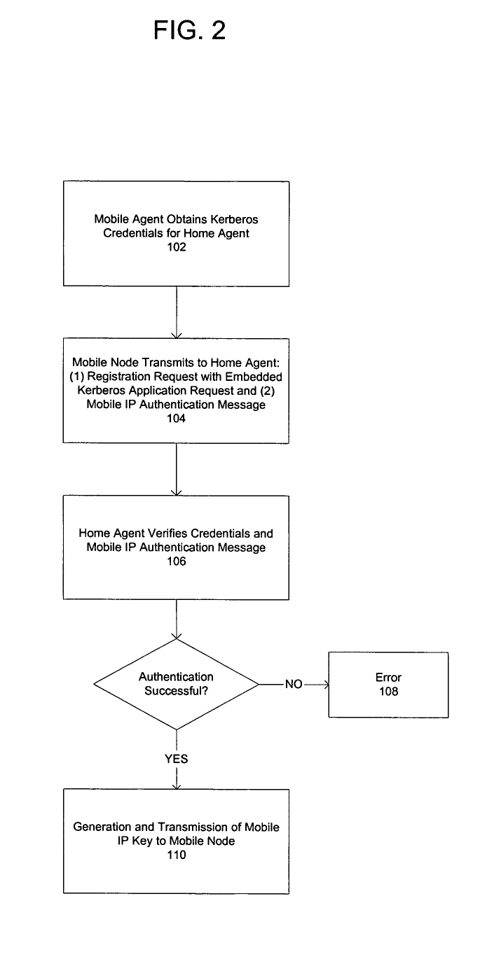

When the mobile node attempt to register a care-of address with a home agent, the home agent authenticates the mobile node to ensure that the device requesting registration of the care-of address is actually the mobile node. Additionally, the home agent may periodically (e.g., every 2 hours) require the mobile node to refresh its authentication. An example of an authentication process for the mobile node is shown in FIG. 2.

Referring to FIG. 2, prior to leaving the home network, a mobile node first obtains 102 Kerberos “credentials” for a home agent (i.e., a session key and a ticket for its home agent). The mobile node transmits 104 its Kerberos credentials to the home agent as part of a Registration Message transmitted to the home agent. The mobile node also transmits a mobile IP authentication message to its home agent.

Upon receipt of the Registration Request and mobile IP authentication message, the home agent extracts and evaluates 106 the credentials and the mobile IP authentication message. If either the credentials or the mobile IP authentication message are not valid, then the home agent generates and transmits 108 an error message to the mobile node denying registration of its care-of address. If the credentials and mobile IP authentication message are valid, the home agent generates 110 a mobile IP key that is encrypted, embedded within a Registration Reply message, and sent to the mobile node. The mobile IP session key is used for subsequent authentication of Registration Request and Reply messages exchanged between the mobile node and home agent.

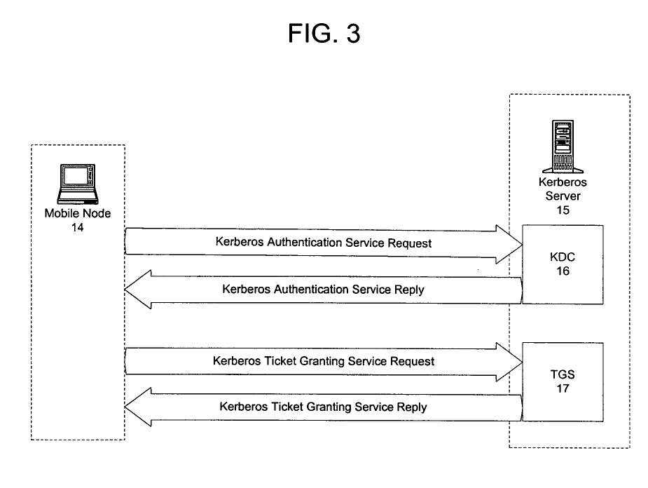

Referring to FIG. 3, a mobile node 14 requests credentials for the Kerberos Ticket Granting Service (TGS) 17 by sending a Kerberos Authentication Service Request (KRB_AS_REQ) to a Kerberos Key Distribution Center (KDC) 16. The Kerberos Authentication Service Request message includes data that identifies the mobile node 14 and the Ticket Granting Service 17 service being requested. The message also includes authentication data intended to prove that the device transmitting the Authentication Service Request message is the mobile node. The authentication data may be a freshly generated timestamp encrypted with the private key of the mobile node (known only by the mobile node and Key Distribution Center 16).

When the Key Distribution Center 16 receives the Authentication Service Request, it looks up the mobile node in a database, gets the associated mobile node's private key, decrypts the authentication data, and evaluates the timestamp inside. If the timestamp is valid, the Key Distribution Center can be assured that the authentication data was encrypted with the mobile node's master key and thus that the mobile node is genuine.

Once it has verified the mobile node's identity, the Key Distribution Center produces credentials that the mobile node can present to the Ticket Granting Service 17. The Key Distribution Center produces credentials by generating a session key and encrypting one copy of the session key with the mobile node's master key. The Key Distribution Center also embeds another copy of the session key and the mobile node's authorization data in a ticket for the Ticket Granting Service, and encrypts the ticket granting service ticket with the master key of the Ticket Granting Service. The Key Distribution Center sends these credentials (i.e., the mobile node-Ticket Granting Service session key and the Ticket Granting Service ticket) back to the mobile node in a Kerberos Authentication Service Reply message.

When the mobile node receives the Authentication Service Reply message, it uses its private key to decrypt the mobile node-Ticket Granting Service session key and stores the session key in memory. The mobile node also extracts the ticket for the Ticket Granting Service from the Authentication Service Reply message and stores the ticket in memory as well.

The mobile node transmits a Kerberos Ticket-Granting Service Request message to the Ticket Granting Service 17 request that resides in the Kerberos server 15. The Ticket-Granting Service Request message includes the identity of the home agent for which the mobile node requests credentials, an authenticator message encrypted with the mobile node-Ticket Granting Service session key, and the ticket for the Ticket Granting Service obtained from the Authentication Service Exchange.

When it receives a Ticket-Granting Service Request, the Ticket Granting Service 17 decrypts the ticket with its private key and extracts the mobile-node-Ticket Granting Service session key that is embedded within the ticket. Next, the Ticket Granting Service uses the extracted mobile-node-Ticket Granting Service session key to decrypt the mobile node's authenticator message to determine if the timestamp in the authenticator message is current.

If the timestamp is current (and thus valid), the TGS produces a session key for the mobile node to share with the home agent (the MN-HA session key) and a ticket for use with the home agent. The ticket is a data structure defined by the Kerberos protocol, e.g., Network Working Group, Request for Comments 1510, The Kerberos Network Authentication Service (V5), September 1993 that includes a client address field including the address of the client requesting the ticket (in this case, the mobile node). When the Ticket Granting Service 17 produces a ticket for a home agent requested by a mobile node it writes zeros in the client address field rather than the permanent IP address of the mobile node in order to allow the mobile node to use the ticket at any network location. The Ticket Granting Service 17 encrypts one copy of the MN-HA session key with the MN-Ticket Granting Service session key and embeds another copy of the MN-HA session key in a ticket for the home agent (the home agent ticket). The Ticket Granting Service 17 encrypts the home agent ticket with the home agent's private key and sends the credentials for the home agent (i.e., the MN-HA session key and the home agent ticket) back to the mobile node in the Kerberos Ticket-Granting Service Reply message.

When the mobile node receives the reply, it decrypts the MN-HA session key with the MN-Ticket Granting Service session key, and stores the MN-HA session key in a ticket cache used by the MN-Ticket Granting Service. The mobile node also extracts home agent ticket for the home agent and stores it in the mobile node's ticket cache.

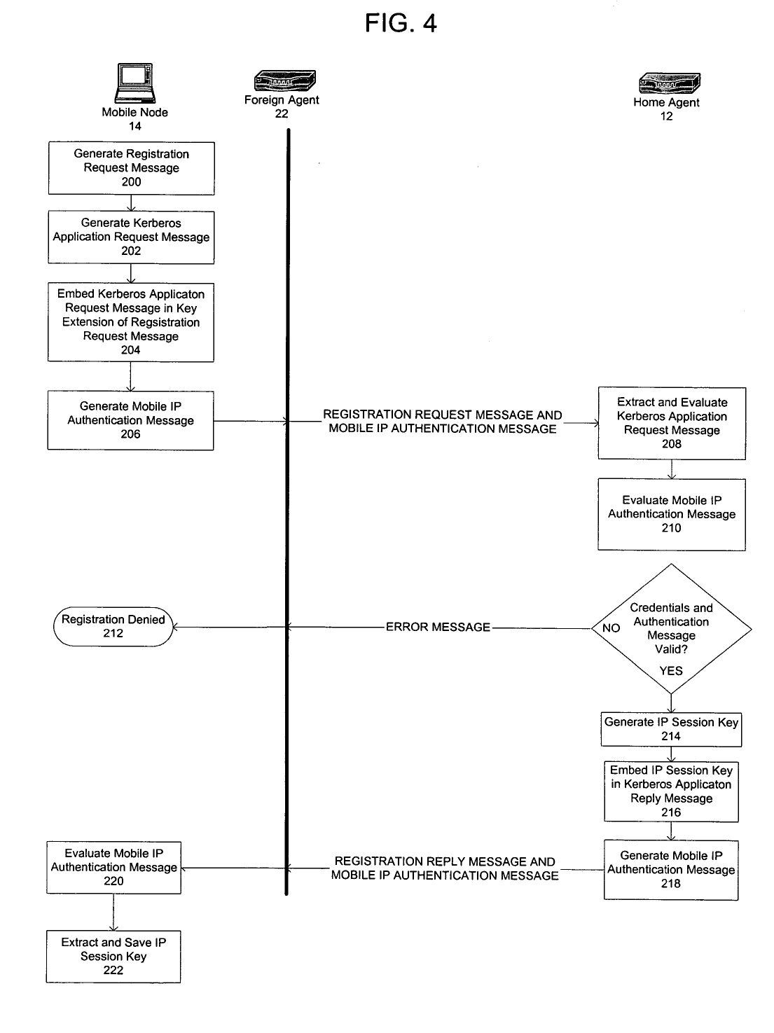

Referring to FIG. 4, after the mobile node 14 receives credentials for its home agent, it may move off of its home network 10. When the mobile needs to register with its home agent, it generates 200 a Registration Request message that includes its care-of address. The mobile node also generates 202 a Kerberos Application Request message, which includes (1) an authenticator message (e.g., a timestamp) encrypted with the MN-HA session key and (2) the ticket for the home agent. The mobile node embeds 204 the Kerberos Application Request within a key extension of the Registration Request message. The key extension is a variable bit extension included within a Registration Request message for negotiation of a key between a mobile node and a home or foreign agent. Mobile IP Working Group, Generalized Key Distribution Extensions for Mobile IP, Internet Draft, 14 Jul. 2000, describes examples of key extensions that may be included in a Registration Request or Registration Reply message.

The mobile node also generates 206 a mobile IP authentication message by applying the cryptographic hash function described in Network Working Group, Request for Comments 2104, “HMAC: Keyed-Hashing for Message Authentication”, February 1997, to the Registration Request message using the MN-HA session key.

The mobile node then transmits the Registration Request (with the embedded Kerberos Application Request) and mobile IP authentication message to the home agent 12 by way of foreign agent 22.

When the home agent receives a Registration Request and Mobile IP authentication message, the home agent extracts and evaluates 204 the Kerberos Application Request from the Registration Request message. The home agent 12 evaluates the Kerberos Application Request by first decrypting the ticket with the private key of the home agent. The home agent 12 then extracts the MN-HA session key from the ticket and uses the MN-HA session key to decrypt the Kerberos authentication message (which is part of the Kerberos Application Request message). The home agent 12 evaluates the timestamp in the Kerberos authentication message to ensure that it is current.

If the ticket and Kerberos authentication message are valid, the home agent evaluates the mobile IP authentication message. The home agent evaluates this message by computing a hash of the Registration Request message using the MN-HA session key and the same hash function used to generate the Mobile IP authentication message and then checking to ensure that the computed hash of the Registration Request message is identical to the Mobile IP authentication message.

If the ticket, Kerberos authentication message, or Mobile IP authentication message are not valid, then an error message is generated and transmitted 212 to the mobile node denying registration of the mobile node's care-of address (and thus access to the home network).

If the ticket, Kerberos authentication message, and Mobile IP authentication message are valid, then the home agent generates 214 a mobile IP session key. The mobile IP session key is produced by any known method of producing encryption keys.

The home agent also produces a Kerberos Application Reply message and embeds 216 the newly-generated mobile IP session key in the Kerberos Application Reply message in the subkey field of the Kerberos Application Reply message, as defined in Network Working Group, Request for Comments 1510, The Kerberos Network Authentication Service (V5), September 1993. The Kerberos Application Reply message is then encrypted with the MN-HA session key and the encrypted Kerberos Application Reply message is embedded 216 with in the key extension of the Registration Reply message. In another implementation, the home agent produces key material, which is encrypted and sent to the mobile node. In this implementation, the home agent and the mobile node each apply a function (known to both the home agent and mobile node) to the key material to independently generate their own copy of a mobile IP session key.

The home agent also generates 218 a mobile IP authentication message by applying a cryptographic hash function to the Registration Request message using the MN-HA session key.

The home agent then transmits the Registration Reply message and the mobile IP authentication message to the mobile node (via the foreign agent). The home agent also saves a copy of the mobile IP session key in memory.

When the mobile node receives the Registration Reply and mobile IP authentication messages, mobile node computes a hash of the Registration Reply message using the MN-HA session key and the same hash function used to generate the Mobile IP authentication message. The mobile node evaluates 220 the received mobile IP authentication message by checking to ensure that the computed hash of the Registration Reply message is identical to the mobile IP authentication message sent with the Registration Reply message.

The mobile node also extracts and decrypts the Kerberos Application Reply message using the MN-HA session key. The mobile agent checks to verify that the timestamp is valid and, if the timestamp and mobile IP authentication message are valid, saves 222 the mobile session IP key in memory.

The mobile IP session key may be used to authenticate subsequent registration requests by the mobile node according to the authentication process described in the IP Mobility Support for IPv4 protocol. For example, if after a mobile IP session key has been exchanged, the mobile node re-contacts its home agent requesting delivery of datagrams at a new care-of address, the mobile node may generate a mobile IP authentication message by computing a hash of the Registration Request message using the mobile IP session key. When the home agent receives the Registration Request message, the home agent also computes a hash of the Registration Request message using its copy of the mobile IP session key and checks to ensure that the computed hash is identical to the mobile IP authentication message sent with the Registration Request message. If the hashes are identical, then the home agent may encrypt a new mobile IP session key with the original mobile IP session key and include it in the Registration Reply message.

Other embodiments are within the scope of the following claims. For example, a mobile IP session key may be refreshed at any time by repeating the processes described in FIGS. 2-4, except that the Kerberos Authentication Service Request and Reply messages and the Kerberos Ticket Granting Service Request and Reply messages (shown in FIG. 2) will be routed through the home agent. Additionally, a mobile node and home agent may exchange registration request and reply messages when the mobile node contacts the home agent directly over a wireless network. Finally, application of the concepts of this description are not limited to use of the Kerberos Authentication protocol, but other authentication techniques may be employed to authenticate a remote mobile node.

1. A machine-implemented method comprising:
producing a first authentication message comprising:
authentication data encrypted with a first key; and
a data structure comprising the first key, wherein the data structure is encrypted with a second key;
generating a request message to have a first network device associated with a first network deliver datagrams destined for a home address associated with a mobile device on the first network to a second address on a second, different network; and
embedding the authentication message in the request message.

2. The method of claim 1 wherein the authentication data comprises a timestamp.

3. The method of claim 1 wherein the second key is known to the first network device and unknown to the mobile node.

4. The method of claim 1 wherein the authentication message comprises a Kerberos Application Request.

5. The method of claim 1 wherein the data structure comprises a Kerberos ticket.

6. The method of claim 1 further comprising generating a second authentication message.

7. The method of claim 6, wherein generating a second authentication message comprises:
generating a hash of the request message using the first key.

8. The method of claim 6 further comprising:
transmitting the request message and second authentication message to the first network device.

9. The method of claim 8 further comprising:
receiving the request message and second authentication message by a device on the home network; and
decrypting the data structure using the second key to obtain the first key.

10. The method of claim 9 further comprising:
verifying the second authentication message using the first key.

11. The method of claim 9 further comprising generating a third key.

12. The method of claim 9 further comprising generating key material, wherein the key material-may be supplied to a function to generate a third key.

13. The method of claim 1 wherein the request message comprises a Registration Request message.

14. The method of claim 11 further comprising:
forming a reply authentication message comprising the third key encrypted with the first key.

15. The method of claim 14 wherein the reply authentication message comprises a Kerberos Application Reply message.

16. The method of claim 14 further comprising:
forming a reply message that includes the reply authentication message.

17. The method of claim 16 wherein the reply message comprises a Registration Reply message.

18. The method of claim 16 further comprising:
generating a third authentication message; and
transmitting the reply message and third authentication message to the mobile node.

19. The method of claim 18 wherein generating a third authentication message comprises:
generating a hash of the reply authentication message using the first key.

20. A machine-implemented method comprising:
receiving at a first device associated with a home network an authentication message and a request message to reroute datagrams destined for a first address of a mobile device associated with the home network to a second address not associated with the home network, wherein the request message comprises:
a data structure that includes a first key encrypted with a second key; and
determining if the authentication message is valid.

21. The method of claim 20 further comprising:
generating a third key if the authentication message is determined to be valid.

22. The method of claim 20 further comprising:
generating key material if the authentication message is determined to be valid, wherein the key material may be supplied to a function known to the first device and the mobile device to produce a third key.

23. The method of claim 20 wherein the authentication message comprises a hash of the request message, wherein the hash is computed using the first key.

24. The method of claim 20 wherein the request message comprises a Registration Request message.

25. The method of claim 23, wherein determining if the authentication message is valid comprises:
computing a hash of the request message using the first key; and
comparing the computed hash to the authentication message.

26. The method of claim 25 further comprising:
decrypting the data structure using the second key to obtain the first key.

27. The method of claim 21 further comprising:
receiving a reply message from the first device by the mobile device, wherein the reply message includes the third key.

28. The method of claim 27 further comprising:
forming a second request message to have datagrams destined for a first address of a mobile device associated with the home network to a third address not associated with the home network;
forming a second authentication message using the third key; and
transmitting the second request message and second authentication message to the first device.

29. A computer program product residing on a computer readable medium having instructions stored thereon that, when executed by the processor, cause that processor to:
form an authentication message comprising:
authentication data encrypted with a first key; and
the first key encrypted with a second key;
generate a request message requesting that datagrams destined for a first Internet Protocol address of a mobile device be routed to a second Internet Protocol address; and
include the authentication request message in the request message.

30. The computer program product of claim 29 wherein the authentication message comprises a Kerberos Application Request message.

31. The computer program product of claim 29 further comprising instructions to generate a hash of the request message using the first key to form a second authentication message.

32. The computer program product of claim 29 further comprising instructions to:
receive a reply message from the first device by the mobile device, wherein the reply message includes a third key;
form a second authentication message using the third key;
transmit a second request message to have datagrams destined for a first address of a mobile device associated with the home network to a third address not associated with the home network, wherein the second authentication message is included in the second request message.

33. A computer program product residing on a computer readable medium having instructions stored thereon that, when executed by the processor, cause that processor to:
extract an authentication message from a message requesting that datagrams destined for a first Internet Protocol address of a mobile device be routed to a second Internet Protocol address, wherein the authentication message comprises:
authentication data encrypted with a first key; and
a data structure comprising the first key, and encrypted with a second key;
verify the authentication data; and
if the authentication data is valid, then generating a third key.

34. The computer program product of claim 33 further comprising instructions that cause the processor to:
form a reply message that includes the third key; and
transmit the reply message to a device associated with the request message.

35. The computer program product of claim 33 further comprising instructions that cause the processor to:
store the encryption key.

36. The computer program product of claim 33 wherein the message comprises a Registration Request message.

37. A system comprising:
a first network device associated with a first network; and
a second network device associated with the first network, the second network device capable of:
producing an authentication message including a data structure comprising the first key with the data structure encrypted with a second key;
generating a request message to have the first network device deliver datagrams destined for a home address associated with the second device on the first network to a second address on a second, different network; and
including the authentication message within the request message.

38. The system of claim 37 wherein the second network device is further capable of forming a second authentication message by computing a hash of the request message using the first key.

39. The system of claim 38 wherein the first network device is capable of receiving the request message and generating a key if the second authentication message is valid.

40. The system of claim 37 wherein the first network device is a router.

41. The system of claim 37 wherein the second network device is a laptop computer.

42. The system of claim 37 further comprising:
a third device capable of producing the first key and the data structure encrypted with the second key.

43. A system comprising:
a router associated with a first network and comprising an input port for receiving datagrams and a switch fabric for determining destination of datagrams; and
a processor capable of:
reading request message to reroute datagrams destined for a first address of a mobile device associated with the first network to a second address associated with a second, different network, wherein the request message includes a data structure comprising a first key unknown to the processor encrypted with a second key that is known to the processor,
verifying an authentication message associated with the request message wherein the authentication message comprises a hashed version of the request message computed using the first key; and
if the authentication message is valid, then generating a third key.

44. The system of claim 43, wherein the processor is further capable of:
encrypting the third key.

45. The system of claim 44, wherein the processor is further capable of:
forming a reply message, wherein the reply message includes the encrypted third key; and
forming a reply authentication message.

46. The method of claim 45 wherein the reply authentication message comprises a hashed version of the reply message.

47. The method of claim 45 further comprising: transmitting the reply message and the reply authentication message to the mobile device at the second address.
